(19) United States
(12) Patent Application Publication
(10) Pub. No.: US 2004/0123691 A1
(43) Pub. Date: Jul. 1, 2004

(54) Ball screw apparatus

(75) Inventor: Eiji Hayashi, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: NSK LTD.

(21) Appl. No.: 10/663,757

(22) Filed: Sep. 17, 2003

(30) Foreign Application Priority Data
Sep. 17, 2002 (JP) P. 2002-270283

(51) Int. Cl. F16H 1/24

(52) U.S. Cl. 74/424.83; 74/424.86

(57) ABSTRACT

A ball screw apparatus has: a screw shaft including a screw groove; a nut movably fitted with the screw shaft and including a screw groove; a large number of balls rollably disposed in a loaded raceway; and a side cap mounted on the outer peripheral portion of the nut and including a ball circulation passage for scooping up the balls rolling along the loaded raceway in a direction coincident with the lead angle of the two screw grooves and returning the balls to the loaded raceway, wherein, the two screw grooves are respectively formed as multiple thread screws and the side cap is disposed on each of the multiple threads.

### BACKGROUND OF THE INVENTION

1. Field of the Invention

The present invention relates to a ball screw apparatus which is used in, for example, industrial machines.

2. Description of the Related Art

A conventional ball screw apparatus of this type is structured such that, with a screw shaft including a screw groove in its outer peripheral surface and extending in the axial direction of the ball screw apparatus, there is fitted a nut including in its inner peripheral surface a screw groove corresponding to the screw groove of the screw shaft, while the screw groove of the nut and the screw groove of the screw shaft are disposed opposed to each other and cooperate together in forming a spiral-shaped loaded raceway. In the loaded raceway, there are disposed a large number of balls serving as rolling bodies in such a manner that they are able to roll along the loaded raceway; and, in case where the screw shaft (or, nut) is rotated, the nut (or, screw shaft) is allowed to move in the axial direction through the rolling movements of the balls.

By the way, when the nut (or, the screw shaft) moves in the axial direction, the balls move while they are rolling along the spiral-shaped loaded raceway formed by the two screw grooves; and, in order to allow the nut (or, the screw shaft) to move continuously, it is necessary to make the balls circulate endlessly.

As a type for making the balls circulate endlessly, generally, there are known a circulation tube type, an end cap type and the like. In the case of the circulation tube type, for example, part of the outer peripheral surface of the nut is formed as a flat surface; in this flat surface, there are formed a pair of circulation holes communicating with the above-mentioned two screw grooves in such a manner that they step over the screw shaft; the two end portions of a substantially U-shaped circulation tube are respectively fitted into the pair of circulation holes; and thus, the balls revolving along the loaded raceway between the two screw grooves are scooped up from the intermediate portion of the loaded raceway by the circulation tube and are returned back to its original loaded raceway, thereby forming a circulation circuit for the balls.

Also, in the case of the end cap type, in a nut, there is formed a ball circulation hole which penetrates through the nut in the axial direction thereof; between an end cap fixed to the axial-direction two end faces of the nut and the end face of the nut, there is formed a ball circulation R portion which allows the ball circulation hole and the above-mentioned two screw grooves to communicate with each other; and, the ball circulation portion, the ball circulation hole and the loaded raceway formed between the two screw grooves cooperate together in forming a ball circulation circuit in which the balls revolving along the loaded raceway are allowed to circulate endlessly.

By the way, for a ball screw apparatus of the above-mentioned circulation tube type, there are practically used a structure in which the above-mentioned two screw grooves are composed of multiple thread screws and a circulation tube is disposed for each of the multiple threads, a structure in which there are formed a plurality of ball circulation circuits in a nut, a structure in which a plurality of nuts are connected together in the axial direction thereof, and the like.

However, in the above ball screw apparatus of a circulation tube type, since the direction to scooping the balls is at right angles to the axial direction of the screw shaft, when the balls advancing in the lead direction along the loaded raceway are moved into the scooping portion of the circulation tube, the advancing direction of the balls is changed suddenly. As a result of this, the balls circulate while they are colliding with the scooping portion of the circulation tube, thereby generating vibrations and noises.

On the other hand, in a ball screw apparatus of the above end cap type, by inclining the ball scooping direction by the ball circulation R portion of the end cap in the direction of the lead angle of the two screw grooves, the balls can be prevented from colliding with the scooping portion of the end cap; and also, even in case where the two screw grooves are respectively composed of multiple thread screws, the ball screw apparatus of the end cap type can also apply. However, a plurality of ball circulation circuits cannot be arranged in parallel to each other in a nut; and, in case where the load capacity is increased, the number of balls (the number of windings) must be increased, which raises a possibility the operation efficiency of the ball screw apparatus can be ill influenced.

Further, in the ball screw apparatus of an end cap type, it is difficult to connect together a plurality of nuts in the axial direction and thus it is difficult to use the ball screw apparatus while a double-nut preload is applied. And, in case where the number of balls in a ball circulation circuit becomes large, the balls are caused to rub against each other strongly, thereby impairing the operation efficiency of the ball screw apparatus.

### SUMMARY OF THE INVENTION

The present invention aims at eliminating the above drawbacks found in the conventional ball screw apparatus. Accordingly, it is an object of the invention to provide a ball screw apparatus which not only can prevent noises and vibrations generated when scooping up the balls and can enhance the load capacity without increasing the number of balls (the number of windings) per ball circulation circuit, but also, similarly to the conventional ball screw apparatus of a circulation tube type, can realize a structure in which the above-mentioned two screw grooves are composed of multiple thread screws and a circulation tube is disposed for each of the multiple threads, a structure in which there are formed a plurality of ball circulation circuits in a nut, and a structure in which a plurality of nuts are connected together in the axial direction.

In attaining the above object, according to the invention as set forth in a first aspect, there is provided a ball screw apparatus having: a screw shaft including a spiral-shaped screw groove formed in an outer peripheral surface thereof; a nut movably fitted with the screw shaft and including a screw groove formed in an inner peripheral surface thereof so as to correspond to the screw groove of the screw shaft; a large number of balls rollably disposed in a loaded raceway formed between the two screw grooves; and a side cap mounted on the outer peripheral portion of the nut and including a ball circulation passage for scooping up the balls rolling along the loaded raceway in a direction coincident with the lead angle of the two screw grooves and returning the balls to the loaded raceway, wherein, the two screw grooves are respectively formed as multiple thread screws and the side cap is disposed on each of the multiple threads.

According to the invention as set forth in a second aspect, there is provides a ball screw apparatus having: a screw shaft including a spiral-shaped screw groove formed in an outer peripheral surface thereof; a nut movably fitted with the screw shaft and including a screw groove formed in an inner peripheral surface thereof so as to correspond to the screw groove of the screw shaft; a large number of balls rollably disposed in a loaded raceway formed between the two screw grooves; and, a side cap mounted on the outer peripheral portion of the nut and including a ball circulation passage for scooping up the balls rolling along the loaded raceway in a direction coincident with the lead angle of the two screw grooves and returning the balls to the loaded raceway, wherein the nut includes a plurality of ball circulation circuits each formed by the loaded raceway and the ball circulation passage.

According to the invention as set forth in a third aspect, a ball screw apparatus as set forth in the second aspect, wherein the circulation movements of the balls in the plurality of ball circulation circuits are carried out by a single side cap.

According to the invention as set forth in a fourth aspect, a ball screw apparatus as set forth in the second aspect, wherein the circulation movements of the balls in the plurality of ball circulation circuits are carried out by the side caps respectively disposed on associated ball circulation circuits.

According to the invention as set forth in a fifth aspect, a ball screw apparatus as set forth in the fourth aspect, wherein a relief portion for prevention of mutual interference between the two side caps is disposed between the mutually adjoining side caps.

According to the invention as set forth in a sixth aspect, a ball screw apparatus as set forth in any one of the second to fifth aspect, wherein a plurality of circulation holes are formed in the outer peripheral portion of the nut in communication with the loaded raceway in order to fit the side cap into the nut, and the plurality of circulation holes are disposed so as to be prevented from interfere with each other.

According to the invention as set forth in a seventh aspect, a ball screw apparatus as set forth in the sixth aspect, wherein the circulation holes are disposed outwardly in the diameter direction of the nut with respect to the center axial line of the nut.

According to the invention as set forth in an eighth aspect, there is provided a ball screw apparatus having: a screw shaft including a spiral-shaped screw groove formed in an outer peripheral surface; a nut movably fitted with the screw shaft and including a screw groove formed in an inner peripheral surface so as to correspond to the screw groove of the screw shaft; a large number of balls rollably disposed in a loaded raceway formed between the two screw grooves, a side cap mounted on the outer peripheral portion of the nut and including a ball circulation passage for scooping up the balls rolling along the loaded raceway in a direction coincident with the lead angle of the two screw grooves and returning the balls to the loaded raceway, wherein a plurality of the nuts are connected together in the axial direction thereof.

According to the above-mentioned respective structures of the invention, since the balls rolling along the loaded raceway between the two screw grooves are scooped up in a direction coincident with the lead angle of the two screw grooves by the ball scooping passage constituting the ball circulation passage of the side cap and are then returned to the original loaded raceway, there is eliminated the possibility that, as in the conventional ball screw apparatus of a circulation tube type, the advancing directions of the balls can be changed suddenly in the circulation portion of the balls.

Thanks to this, it is possible to realize a ball screw which not only can prevent noises and vibrations when scooping up the balls and can increase the load capacity without increasing the number of balls (the number of windings) per ball circulation circuit, but also, similarly to the conventional ball screw apparatus of a circulation tube type, can employ a structure in which the two screw grooves are formed as multiple thread screws and the side cap is disposed on each of the multiple threads, a structure including a plurality of ball circulation circuits in a nut, or a structure in which a plurality of nuts are connected together in the axial direction thereof.

### BRIEF DESCRIPTION OF THE DRAWINGS

FIG. 1 is a plan view of a ball screw apparatus of a side cap type according to a first embodiment of the invention;

FIG. 2 is a view of the ball screw apparatus shown in FIG. 1, when it is viewed from the arrow mark A direction shown in FIG. 1;

FIG. 3 is a section view, taken along the arrow line X-X shown in FIG. 2;

FIG. 4 is a plan view of a ball screw apparatus of a side cap type according to a second embodiment of the invention;

FIG. 5 is a plan view of a ball screw apparatus of a side cap type according to a third embodiment of the invention;

FIG. 6 is a plan view of a ball screw apparatus of a side cap type according to a fourth embodiment of the invention;

FIGS. 7A to E each shows a side cap division member obtained when a side cap used in a ball screw apparatus of a side cap type shown in FIG. 6 is divided into two division members; specifically, FIG. 7A is a plan view of the side cap division member; FIG. 7B is a view of the side cap division member, when it is viewed from the arrow mark A direction shown in FIG. 7A; FIG. 7C is a view thereof, when it is viewed from the arrow mark B direction shown in FIG. 7B; FIG. 7D is a section view thereof, taken along the line Y-Y shown in FIG. 7A; and, FIG. 7E is a view thereof, when it is viewed from the arrow mark X direction shown in FIG. 7A; and,

FIGS. 8A to 8E each shows an example in which a pair of side cap division members are connected together through their respective connecting surfaces to thereby form a complete side cap; specifically, FIG. 8A is a plan view of the side cap; FIG. 8B is a view thereof, when it is viewed from the arrow mark A direction shown in FIG. 8A; FIG. 8C is a view thereof, when it is viewed from the arrow mark B direction shown in FIG. 8B; FIG. 8D is a view thereof, when it is viewed from the arrow mark X direction shown in FIG. 8A; and, FIG. 8E is a section view, taken along the line Y-Y shown in FIG. 8A.

### DETAILED DESCRIPTION OF THE PREFERRED EMBODIMENTS

Now, description will be given below of the mode for carrying out the invention with reference to the accompanying drawings.

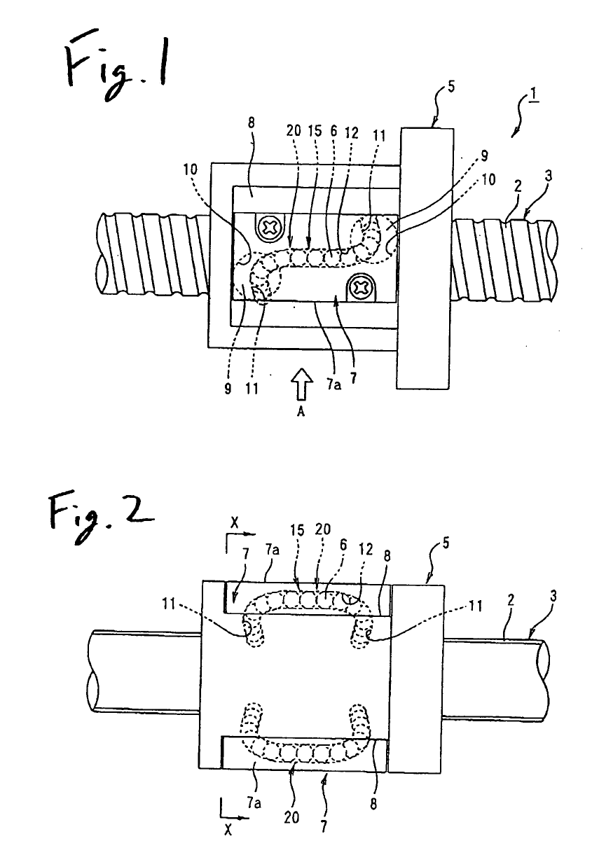

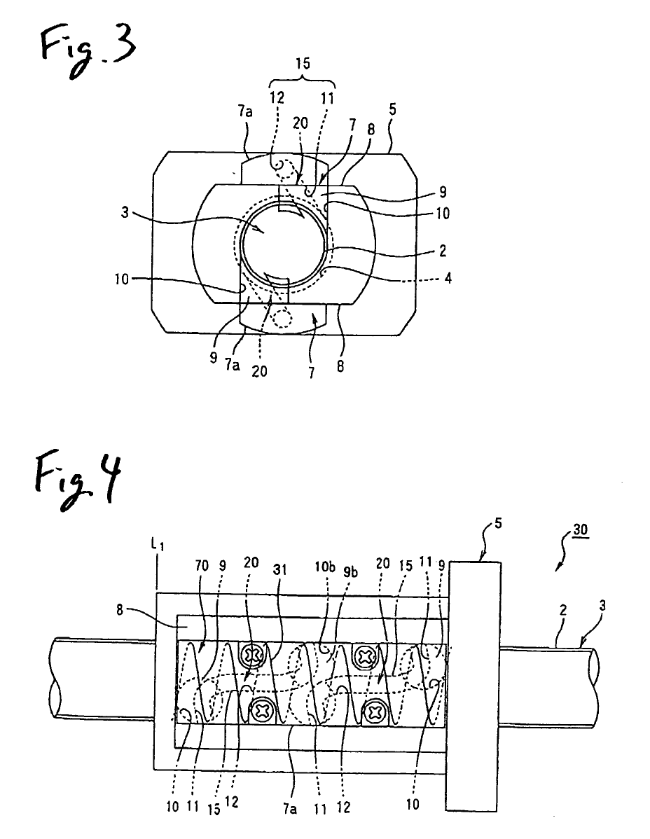

Here, FIG. 1 is a plan view of a ball screw apparatus of a side cap type according to a first embodiment of the invention; FIG. 2 is a view of the above ball screw apparatus, when it is viewed from the arrow mark A direction shown in FIG. 1; FIG. 3 is a section view, taken along the arrow line X-X shown in FIG. 2; and, FIGS. 4 to 8 are respectively explanatory views of other embodiments of a ball screw apparatus of a side cap type according to the invention.

In the ball screw apparatus 1 of a side cap type according to the first embodiment of the invention, as shown in FIGS. 1 to 3, with a screw shaft 3 including a spiral-shaped screw groove 2 in its outer peripheral surface and extending in the axial direction, there is fitted a nut 5 including in its inner peripheral surface a spiral-shaped screw groove 4 which is formed so as to correspond to the screw groove 2; and, the screw groove 4 of the nut 5 and the screw groove 2 of the screw shaft 3 are disposed opposed to each other and cooperate together in forming two spiral-shaped loaded raceways between them. In the loaded raceways, there are disposed a large number of balls 6 serving as rolling bodies in such a manner that they are allowed to roll on and along the loaded raceways; and, in case where the screw shaft 3 (or, nut 5) is rotated, the nut 5 (or, screw shaft 3) is allowed to move in the axial direction due to the rolling movements of the balls 6.

In the outer peripheral surface of the nut 5, there is formed a flat surface which can be used as a mounting surface 8 and, to the mounting surface 8, there is fixed the cap main body 7a of a side cap 7 using fixing means such as a screw. On the lower surface side of the cap main body 7a, there are disposed a pair of pillar-shaped or block-shaped ball scooping portions 9 which extend in a direction perpendicular to the axial direction of the screw shaft 3 in such a manner that they are spaced apart from each other not only in the axial direction of the screw shaft 3 but also in the radial direction of the screw shaft 3. These ball scooping portions 9 are respectively fitted with a pair of circulation holes 10 which are opened up in the mounting surface 8 so as to communicate with the loaded raceways formed between the screw grooves 2, 4; and, in this state, the cap main body 7a is fixed to the mounting surface 8 by fixing means such as a screw.

In the interior portions of the two ball scooping portions 9, there are formed two ball scooping passages 11 which respectively extend in a direction coincident with the lead angles of the screw grooves 2, 4; and, in the interior portion of the cap main body 7a, there is formed a ball passage 12 which connects together these two ball scooping passages 11.

And, the two ball scooping passage 11 and ball passage 12 cooperate together in forming a ball circulation passage 15 in the interior of the side cap 7, where the balls 6 rolling along one (or the other) of the axial-direction loaded raceways between the two screw grooves 2, 4 can be scooped up in the direction coincident with the lead angles of the two screw grooves 2, 4 and are returned to the other (or one) of the axial-direction loaded raceways; and, the present ball circulation passage 15 and the loaded raceways between the two screw grooves 2, 4 cooperate together in forming a ball circulation circuit 20.

Here, in the present embodiment, in order that the two screw grooves 2, 4 are respectively formed as two-thread screws and the balls 6 are allowed to circulate in each of the two threads, there are disposed two side caps 7 of the above-mentioned type so as to be spaced by 180° from each other, thereby forming two ball circulation circuits 20 of the above-mentioned type.

The present ball screw apparatus 1 of a side cap type is different from the conventional ball screw (of a tube type and the like) in that, while the pair of ball scooping portions 9 are simply fitted into the circulation holes 10 formed in the mounting surface 8 of the nut 5 with little clearance between them, the ball scooping passages 11 formed in the interior portions of the ball scooping portions 9 can be inclined with respect to the axial direction of the nut-5-side circulation hole 10.

Thanks to this, similarly to the conventional ball screw apparatus of a circulation tube type, while employing a structure in which the circulation holes 10 are previously formed in the mounting surface 8 of the nut 5 and the ball scooping portions 9 of the side caps 7 are simply fitted into these circulation holes 10, the advancing directions of the balls 6 in the ball scooping passages 11 formed in the ball scooping portions 9 can be inclined in the lead direction of the two screw grooves 2, 4.

This can prevent the sudden change in the advancing direction of the balls 6 in the circulation portion which can often occur in the conventional ball screw apparatus of a circulation tube type, thereby being able to prevent noises and vibrations which can be otherwise generated when the balls 6 are scooped up; and also, unlike the conventional ball screw apparatus of an end cap type, the load capacity of the ball screw apparatus can be enhanced without increasing the number of balls (the number of windings) per ball circulation circuit 20.

Also, in a conventional ball screw apparatus of a deflector type, a side cap 7 is manufactured in such a manner that a pair of ball scooping portions 9 and a cap main body 7a are produced separately and, after then, they are combined together. However, according to the present embodiment, a pair of ball scooping portions 9 and a cap main body 7a are formed so as to be continuous with each other and, therefore, there is no step portion which can be otherwise caused by the connecting portions of the pair of ball scooping portion 9 and the ball circulation passage 15 formed in the interior of the cap main body 7a. This can eliminate the possibility that the balls 6 can collide with the step portion in the ball circulation passage 15 to thereby generate noises and vibrations.

Next, description will be given below of other embodiments of a ball screw apparatus of a side cap type according to of the invention with reference to FIGS. 4 to 8E. By the way, in all of the following embodiments, like parts as in the above-described first embodiment are given the same designations in their respective drawings and thus the detailed description thereof is omitted.

Now, FIG. 4 shows a ball screw apparatus of a side cap type according to a second embodiment of the invention. In the present ball screw apparatus 30, two screw grooves 2, 4 are respectively composed of a one-thread screw; and, in one nut 5, there are disposed two ball circulation circuits 20 each of which is formed by two loaded raceways between two screw grooves 2, 4 and a ball circulation passage 15, while the two ball circulation circuits 20 are spaced from each other in the axial direction of the nut 5. The circulation movements of the balls 6 along the two ball circulation circuits 20 are carried out by one side cap 70, which can reduce the number of parts and thus can simplify the assembly of the ball screw apparatus.

Also, in FIG. 4, reference character 10 designates a circulation hole which connects two circulation holes 10 to each other; and, into the circulation hole 10, there can be fitted a ball scooping portion connecting body 9b which connects together two ball scooping portions 9. By the way, reference character 31 stands for a center raceway of the two screw grooves 2, 4.

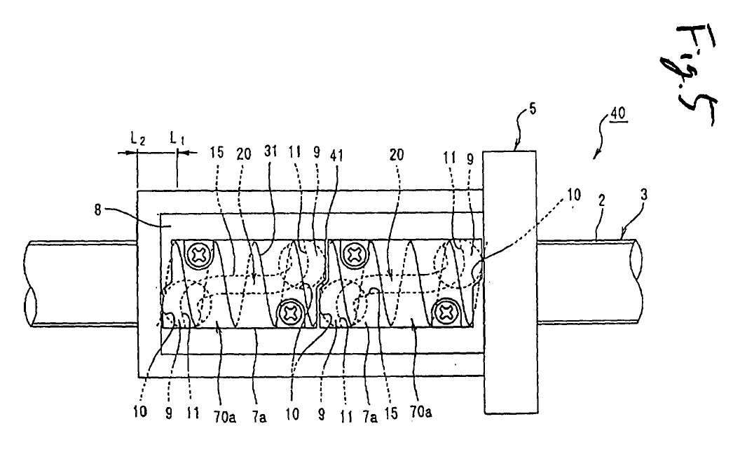

Now, FIG. 5 shows a ball screw apparatus of a side cap type according to a third embodiment of the invention. In the present ball screw apparatus 40, similarly to the above-mentioned second embodiment, two screw grooves 2, 4 are respectively composed of a one-thread screw; and, in one nut 5, there are disposed two ball circulation circuits 20 each of which is formed by two loaded raceways defined by and between two screw grooves 2, 4 and a ball circulation passage 15, while the two ball circulation circuits 20 are spaced from each other in the axial direction of the nut 5. However, the third embodiment is different from the second embodiment in that the circulatory movements of the balls 6 in the two ball circulation circuits 20 are carried out by two side caps 70a respectively disposed in their associated ball circulation circuits 20. By the way, in FIG. 5, reference character 41 designates a relief portion which is used to prevent mutual interference between the mutually adjoining side caps 70a.

In this manner, since the circulation movements of the balls 6 in a plurality of ball circulation circuits 20 are carried out by the two side caps 70a which are respectively disposed in their associated ball circulation circuits 20, in case where the number of ball circulation circuits 20 is one, two, or more, it is possible to use the side cap 70a in common. Therefore, side caps for use in various types of ball screw apparatus can be mass produced in the same shape, thereby being able to reduce the cost of the ball screw apparatus.

By the way, as in the embodiment illustrated in FIG. 5, in case where the side caps 70a having the same shape are used in every ball circulation circuits 20, it is necessary to avoid mutual interference between the mutually adjoining side caps 70a or between the mutually adjoining circulation holes 10.

In the embodiment shown in FIG. 5, the above mutual interference is avoided by shifting the left side (in FIG. 5) ball circulation circuit 20 of the two ball circulation circuits 20 to the left by an amount corresponding to 1 lead (a dimension up to L₁˜L₂, in FIG. 5) when compared with the second embodiment shown in FIG. 4. Due to this, the above mutual interference is eliminated, whereas the whole length of the nut 5 is extended by al lead amount over the embodiment shown in FIG. 4. Generally, to extend the whole length of the nut leads to the shortened effective stroke of the ball screw apparatus: that is, preferably, the nut whole length may be set short.

On the other hand, in FIG. 6, there is shown an embodiment which can avoid the mutual interference between the mutually adjoining side caps or circulation holes without extending the whole length of the nut.

Here, FIG. 6 shows a ball screw apparatus of a side cap type which is a fourth embodiment according to the invention. In the present ball screw apparatus 50, similarly to the above-mentioned third embodiment, two screw grooves 2, 4 are respectively composed of a one-thread screw; and, in one nut 5, there are disposed two ball circulation circuits 20 each of which is formed by two loaded raceways between two screw grooves 2, 4 and a ball circulation passage 15, while the two ball circulation circuits 20 are spaced from each other in the axial direction of the nut 5; and also, the circulatory movements of the balls 6 in the two ball circulation circuits 20 are carried out by two side caps 70b respectively disposed in their associated ball circulation circuits 20. However, the fourth embodiment is different from the third embodiment that circulation holes 10 are disposed outwardly in the diameter direction of a nut 5 with respect to the center axis line 51 of the nut 5. By the way, in FIG. 6, reference character 52 designates a relief portion for preventing the mutual interference between the two mutually adjoining side caps 70b.

In this manner, by disposing the circulation holes 10 at positions which do not reach the center axis line 51, while avoiding the mutual interference between the two mutually adjoining side caps 70b or circulation holes 10, the two side caps 70b can be arranged in such a manner that the two ball circulation circuits 20 are set at the same positions as in the embodiment shown in FIG. 4. Therefore, a common side cap 70b can be used in the respective ball circulation circuits without extending the whole length of the nut 5.

By the way, in the above-mentioned embodiments, for convenience of explanation, as the side cap, there is shown a side cap which is formed as an integral body; however, the side cap may also be divided into two or more division members and the thus-divided division members may be then connected together at their divided positions to thereby form a complete side cap

Also, in case where the above-mentioned side caps are made by injection molding of synthetic resin, they can be mass produced at a low cost. However, they can also be made of metal by sintering or by MIM.

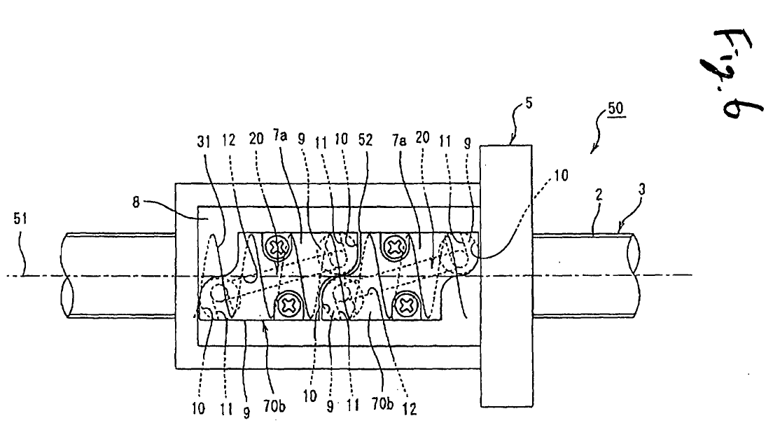

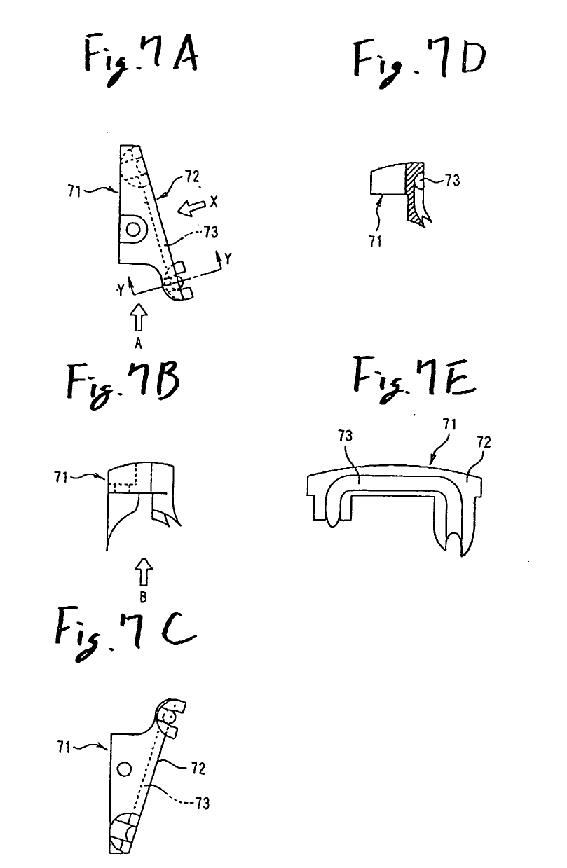

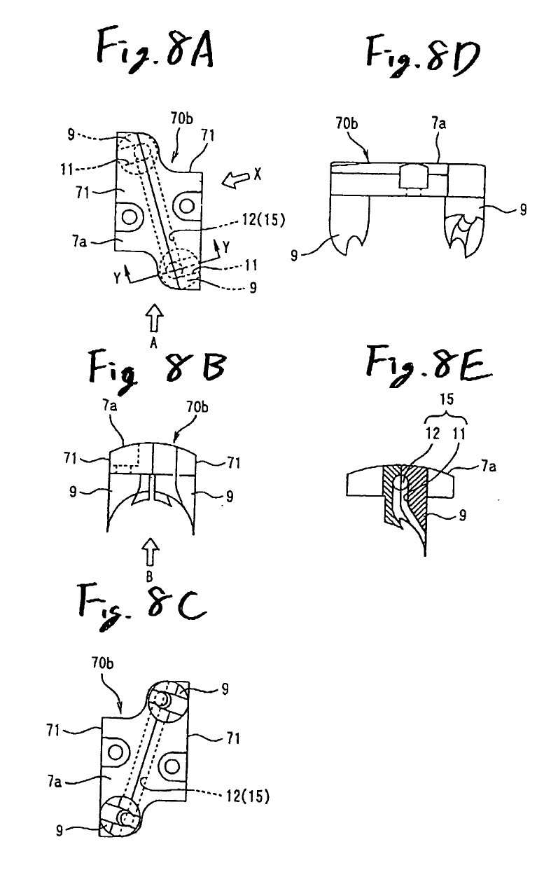

Now, FIGS. 7 and 8 show the side cap 70b used in the ball screw apparatus 50 of a side cap type shown in FIG. 6. Here, FIG. 7 shows a side cap division member 71 obtained by dividing the side cap 70b into two division members along the ball circulation passage 15. In FIG. 7, reference character 72 designates the connecting surface of the side cap division member 71, while 73 stands for a ball circulation groove having a semicircular section formed in the connecting surface 72. And, in case where the connecting surfaces 72 of the two side cap division members 71 are connected to each other, there is provided a side cap 70b shown in FIG. 8; and, the ball circulation groove 73 formed in the connecting surface 72 provides, in the interior of the side cap 70b, a ball circulation passage 15 which allows the balls 6 to circulate. Also, the ball scooping portion 9 of the side cap 70b is fitted into the circulation hole 10 of the nut 5.

In this manner, since the side cap division members 71 of the same size are combined together to thereby form the side cap 70b, the kind of parts can be reduced. Also, because the a common side cap can be used in a plurality of ball circulation circuits 20 in the above-mentioned manner, especially, in case where the side caps are produced using a mold, for example, they are produced by injection molding, the common side cap can be mass produced and used, which leads to reduction in the manufacturing costs of the side caps and thus the ball screw apparatus.

By the way, the structure of a ball screw apparatus of a side cap type according to the invention is not limited to the above-mentioned embodiments but various changes and modifications are possible without departing from the gist of the invention.

For example, in the above embodiments, there is taken an instance in which a plurality of ball circulation circuits 20 are formed in a nut 5. However, instead of this, there can also be employed a structure in which a nut with a plurality of side caps each including at least one ball circulation circuit 20 are connected together in the axial direction thereof.

As can be understood clearly from the foregoing description, according to the invention, there can be provided a ball screw apparatus which not only can prevent noises and vibrations when scooping up balls, can enhance the load capacity without increasing the number of balls (the number of windings) per ball circulation circuit, but also, similarly to the conventional ball screw apparatus of a circulation tube type, can realize a structure in which the above-mentioned two screw grooves are respectively formed as multiple thread screws and a side cap is disposed in each of the multiple threads, a structure in which a plurality of ball circulation circuits are formed in a nut, or a structure in which a plurality of nuts are connected together in the axial direction thereof.

What is claimed is:

1. A ball screw apparatus comprising:
a screw shaft including a spiral-shaped screw groove formed in an outer peripheral surface thereof;
a nut movably fitted with the screw shaft and including a screw groove formed in an inner peripheral surface thereof so as to correspond to the screw groove of the screw shaft;
a large number of balls rollably disposed in a loaded raceway formed between the two screw grooves; and
a side cap mounted on the outer peripheral portion of the nut and including a ball circulation passage for scooping up the balls rolling along the loaded raceway in a direction coincident with the lead angle of the two screw grooves and returning the balls to the loaded raceway,
wherein, the two screw grooves are respectively formed as multiple thread screws and the side cap is disposed on each of the multiple threads.

2. A ball screw apparatus comprising:
a screw shaft including a spiral-shaped screw groove formed in an outer peripheral surface thereof;
a nut movably fitted with the screw shaft and including a screw groove formed in an inner peripheral surface thereof so as to correspond to the screw groove of the screw shaft;
a large number of balls rollably disposed in a loaded raceway formed between the two screw grooves; and,
a side cap mounted on the outer peripheral portion of the nut and including a ball circulation passage for scooping up the balls rolling along the loaded raceway in a direction coincident with the lead angle of the two screw grooves and returning the balls to the loaded raceway,
wherein the nut includes a plurality of ball circulation circuits each formed by the loaded raceway and the ball circulation passage.

3. A ball screw apparatus as set forth in claim 2, wherein the circulation movements of the balls in the plurality of ball circulation circuits are carried out by a single side cap.

4. A ball screw apparatus as set forth in claim 2, wherein the circulation movements of the balls in the plurality of ball circulation circuits are carried out by the side caps respectively disposed on associated ball circulation circuits.

5. A ball screw apparatus as set forth in claim 4, wherein a relief portion for prevention of mutual interference between the two side caps is disposed between the mutually adjoining side caps.

6. A ball screw apparatus as set forth in claim 2, wherein a plurality of circulation holes are formed in the outer peripheral portion of the nut in communication with the loaded raceway in order to fit the side cap into the nut, and the plurality of circulation holes are disposed so as to be prevented from interfere with each other.

7. A ball screw apparatus as set forth in claim 3, wherein a plurality of circulation holes are formed in the outer peripheral portion of the nut in communication with the loaded raceway in order to fit the side cap into the nut, and the plurality of circulation holes are disposed so as to be prevented from interfere with each other.

8. A ball screw apparatus as set forth in claim 4, wherein a plurality of circulation holes are formed in the outer peripheral portion of the nut in communication with the loaded raceway in order to fit the side cap into the nut, and the plurality of circulation holes are disposed so as to be prevented from interfere with each other.

9. A ball screw apparatus as set forth in claim 5, wherein a plurality of circulation holes are formed in the outer peripheral portion of the nut in communication with the loaded raceway in order to fit the side cap into the nut, and the plurality of circulation holes are disposed so as to be prevented from interfere with each other.

10. A ball screw apparatus as set forth in claim 6, wherein the circulation holes are disposed outwardly in the diameter direction of the nut with respect to the center axial line of the nut.

11. A ball screw apparatus as set forth in claim 7, wherein the circulation holes are disposed outwardly in the diameter direction of the nut with respect to the center axial line of the nut.

12. A ball screw apparatus as set forth in claim 8, wherein the circulation holes are disposed outwardly in the diameter direction of the nut with respect to the center axial line of the nut.

13. A ball screw apparatus as set forth in claim 9, wherein the circulation holes are disposed outwardly in the diameter direction of the nut with respect to the center axial line of the nut.

14. A ball screw apparatus comprising:
a screw shaft including a spiral-shaped screw groove formed in an outer peripheral surface;
a nut movably fitted with the screw shaft and including a screw groove formed in an inner peripheral surface so as to correspond to the screw groove of the screw shaft;
a large number of balls rollably disposed in a loaded raceway formed between the two screw grooves,
a side cap mounted on the outer peripheral portion of the nut and including a ball circulation passage for scooping up the balls rolling along the loaded raceway in a direction coincident with the lead angle of the two screw grooves and returning the balls to the loaded raceway,
wherein a plurality of the nuts are connected together in the axial direction thereof.
